(19) United States
(12) Patent Application Publication
(10) Pub. No.: US 2008/0109440 A1
(43) Pub. Date: May 8, 2008

(54) Recording/reproducing apparatus

(75) Inventor: Osamu Uchiyama, Hiratsuka (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Hitachi, Ltd., Tokyo (JP); Hitachi-LG Data Storage Inc., Tokyo (JP)

(21) Appl. No.: 11/900,970

(22) Filed: Sep. 14, 2007

(30) Foreign Application Priority Data
Nov. 2, 2006 (JP) 2006-298412

(51) Int. Cl. G06F 17/30

(52) U.S. Cl. 707/9; 707/1; 707/E17.005

(57) ABSTRACT

A recording/reproducing apparatus, comprises a recording/reproducing portion, which is configured to record contents data coded on media, being same in a copyright protection regulation that is applied by the media differing in formats thereof, and to reproduce the contents data on the media, and a coding processor portion, which is configured to take out coded information of the contents data, to conduct a coding process thereon, wherein identification is made on format information of the medium, to hold the coding information within the apparatus, separately, for each of the format information, thereby holding the information of copyright protection regulations of the media differing in the formats thereof, so as to share them in common.

### BACKGROUND OF THE INVENTION

The present invention relates to a recording/reproducing apparatus for dealing with contents data on plural kinds of media, each being different on the format thereof, upon which copyright protection is made, and in particular, it relates to that for enabling to process coded information thereof, with certainty.

Conventionally, the following Patent Document 1 is already known, in relation to the code processing of contents, upon which the copyright protection is made.

This is proposed for the purpose of executing the process accompanying the movement of the contents, upon which the copyright protection is made, over plural kinds of media, with certainty.

Also, the following Patent Document 2 relates to a method for maintaining mutual compatibility between specific apparatuses, with certainty, by coding the contents, upon which the copyright protection is made, with using plural numbers of coding keys, in advance.

[Patent Document 1] Japanese Patent Laying-Open No. 2006-195973 (2006); and

[Patent Document 2] Japanese Patent Laying-Open No. 2006-211710 (2006).

### BRIEF SUMMARY OF THE INVENTION

With the conventional arts mentioned above, however, there is paid no consideration upon a method for reproducing the contents with certainty, upon which the protection is made with the same regulation of the copyright protection, on the medium of another format, i.e., being different in the specification, such as, a track pitch and a position in the plate thickness direction on the recording surface thereof, for example.

Normally, under the regulation of the copyright protection, an implementation specification thereof is regulated for each format of the different kinds of media, and in case when conducting to reproduce the disks of both regulations, with using one (1) set of an optical disk drive apparatus, there is clear indication on each of the regulations of those, in relation to the dealing of the coding information on the disks, however, no consideration was paid on a method for commonly sharing the information within the drive apparatus, in particular, in relation to the coding information on the disk of each format, when trying to develop an apparatus for achieving compatible reproduction of the different media.

Further, within the recent copyright protection regulation, as a countermeasure for self-defense in the case of unlike leakage of the coding key is implemented a function of identifying the apparatus that makes the leakage, thereby to disable or revoke the operation of that apparatus identified. In accordance with the mechanism of this, ID information (given by an origin of issuing a license), being unique to the apparatus to be revoked, is held within a revocation list, which is recorded on each medium. Then, when the medium is loaded into the drive apparatus, the revocation list thereof is read in, and the operation of the apparatus is revoked if the ID of that apparatus is in the list.

This revocation list is compared with the version of the revocation list, which is reserved within the apparatus in advance, at the time point when the medium is loaded therein, and it is replaced by the list if the version of the apparatus revocation list on the medium is new, thereby holding the new version of the apparatus, always within the drive apparatus.

Also, the origin that issues the license, in the mechanism thereof, specifies the ID of that apparatus when the phenomenon occurs, such as, the leakage of the key information, etc., for example, and attaches the newest revocation list renewed on the media, which will be issued newly, thereby maintaining the revocation list held within the apparatus to be the newest version within the apparatus.

On the other hand, even with a drive apparatus of enabling reproduction of the media of a plural number of formats, since the compatibility cannot be guaranteed for each of the formats of the revocation lists, upon the regulation, therefore, for the purpose of achieving the reproduction, with certainty, on media of a plural number of formats within the drive apparatus, it is necessary to conduct a certification process and a coding process, with using the revocation information for each of the formats, within that drive apparatus.

However, with the drive apparatus in accordance with that regulation, no consideration was paid in relation to the reproducing process of the media, the copyrights of which are protected under a plural number of formats, and then it is necessary to hold the revocation information and the coding information, effectively, for each of the formats within the drive apparatus for achieving the compatible reproduction.

According to the present invention, it is an object thereof to provide a method for enabling the reproduction thereof, with certainty, while holding the coding information for each format, in particular, when reproducing the contents, the copyright of which is protected, on the plural number of formats thereof.

As a means for dissolving such the object as was mention above, according to the present invention, wherein coding information of a plural number of formats, upon which the copyright protection is made, is held, separately, for each of the formats, and an identification is made on a medium, at a time-point when a medium is loaded into the drive apparatus, and after identifying the format information, the information necessary for each format is held within the drive apparatus, separately, thereby enabling to reproduce the contents, upon which the copyright protection is made, accurately, upon the plural number of formats thereof.

According to the present invention, it is possible to conduct reproduction of the contents, being recorded on a plural number of independent formats and the copyrights thereof, are protected, accurately or correctly, by one (1) set of the drive.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1(a) is a brief construction view for showing a recording/reproducing apparatus, according to an embodiment of the present invention;

FIG. 1(b) is also a brief construction view for showing the recording/reproducing apparatus, according to an embodiment of the present invention;

FIG. 2 is a flowchart for showing an example of processing steps of coding information and apparatus revocation information, after identifying a medium, according to the present invention;

FIG. 3 is a brief construction view for showing a recording/reproducing apparatus, according to other embodiment of the present invention;

FIG. 4 is a brief construction view for showing the one embodiment of the recording/reproducing apparatus, in particular, when recording; and

FIGS. 5(a) and 5(b) are views for showing processing steps of a coding process, briefly, when recording, according to the one embodiment.

### DETAILED DESCRIPTION OF THE INVENTION

Hereinafter, embodiments according to the present invention will be fully explained, by referring to the attached drawings.

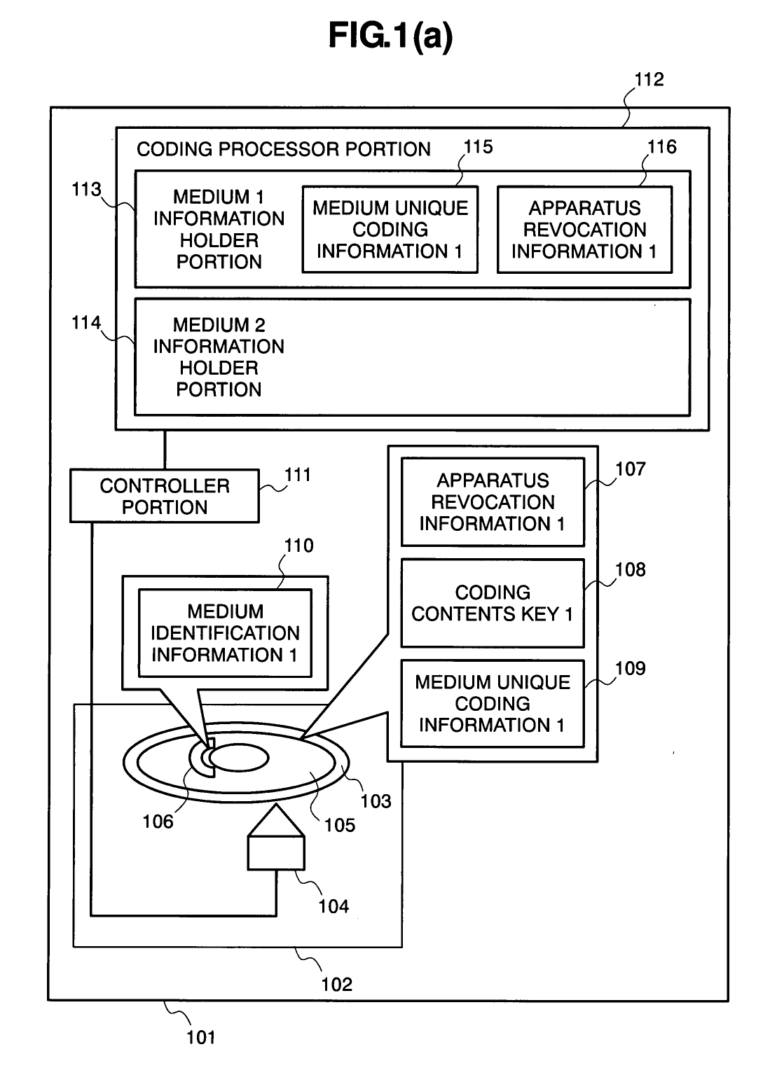

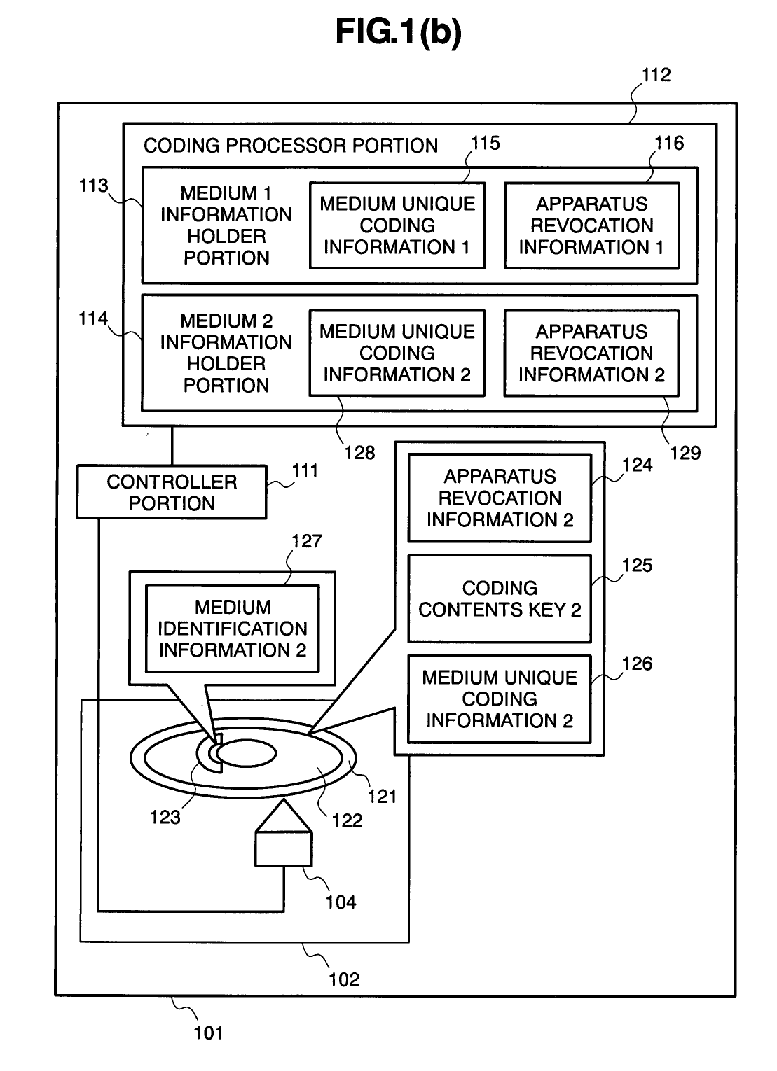

Hereinafter, explanation will be made on a one embodiment of the present invention, by referring to FIGS. 1, 2, 3, 4 and 5.

FIG. 1(a) is a brief construction view for showing a recording/reproducing apparatus, according to an embodiment of the present invention.

A reference numeral 101 depicts a recording/reproducing apparatus, according to the present invention, 102 an optical disk recording apparatus within the recording/reproducing apparatus mentioned above, and 105 a contents recording area or region, for recording apparatus revocation information (1) 107 therein, being recorded on the optical disk 103 and relating to the copyright on a format “a” of the optical disk 103 and a coding contents key (1) 108 for coding the contents mentioned above, and also medium unique coding information (1) 109 to be used in coding for each medium.

A reference numeral 104 depicts an optical pickup for conducting recording/reproducing upon the optical disk 103 mentioned above, 106 a specific area or region on the recording medium 103, where medium identification information (1) 110 is recorded on the optical disk 103 mentioned above, to be used as identification data. A reference numeral 111 depicts a controller portion for controlling recording/reproducing operation of the recording apparatus 102 mentioned above, 112 a coding process portion, including a medium 1 information holder portion 113 and a medium 2 information holder portion 114 therein, wherein apparatus revocation information (1) 116 and medium unique coding information (1) 115 are held in the medium 1 information holder portion 113. As is shown in FIG. 1(a), the optical pickup 104 reads out the medium identification information (1) 110, so as to determine a king or sort of the medium, and holds the medium unique coding information (1) 115 and the apparatus revocation information (1) 116 within the corresponding medium 1 information holder portion 113 in the coding process portion 112. In case that there is an ID number corresponding to the apparatus mentioned above within the apparatus revocation information, then operation of the apparatus is vacated, i.e., stopping the operation thereof, such as, recording/reproducing, for example.

Also, FIG. 1(b) shows an example, when loading an optical disk 121 into the recording/reproducing apparatus 101, according to the present invention, which applies the same regulation of copyright protection, although it differs from the example shown in FIG. 1(a), in the formats thereof, for example, a recording pitch, a position of recording surface in the direction of a plate thickness, etc. However, the components or structures, being similar to those shown in the previous figure (i.e., FIG. 1(a)), are attached with the same reference numerals. In this FIG. 1(b), a reference numeral 122 depicts a contents recording area or region, where are recorded apparatus revocation information (2) 124, which is recorded on the optical disk 121 and relates to the copyright protection on a format “b” of the optical disk 121, a coding contents key (2) 125 for conducting the coding on the contents mentioned above, and medium unique coding information (2) 126 to be used in coding for each medium, and 123 a specific area or region on the recording medium 121, i.e., a protection area for recording medium identification information (2) 127, to be used as the identification data on the optical disk 121 mentioned above, therein.

As is shown in FIG. 1(b), the medium determination is conducted upon the optical disk 121 loaded therein, by means of the medium identification information (2) 127, and coding information (2) 128 and apparatus revocation information (2) 129, being unique to that medium, are held within the medium 2 information holder portion 114, in accordance with the format recorded on that medium. As is shown in FIGS. 1(a) and 1(b), with holding the coding information of the different formats within each of the medium information holder portions, it is possible to reproduce the contents on the medium of the plural number of formats, which are protected by the same copyright regulation, with certainty. Further, with holding the apparatus revocation information for each of the media, independently, it is possible to achieve a certifying operation for the apparatus, with certainty, even in the case there is no compatibility, for example, when the apparatus revocation information differs from, in the version thereof, for each of the formats.

However, the identification information of the format of the optical disk may also be determined, other than the data recorded on the optical disk, by the information when making an adjustment on the drive, such as, an amount of reflection light between the optical head and the optical disk or the distance between them when a focus adjustment is made, the position of a recoding film or layer of the disk in the direction of disk thickness, or the kind of the laser light (i.e., a red-color or a blue-color laser) that is finally determined, for example.

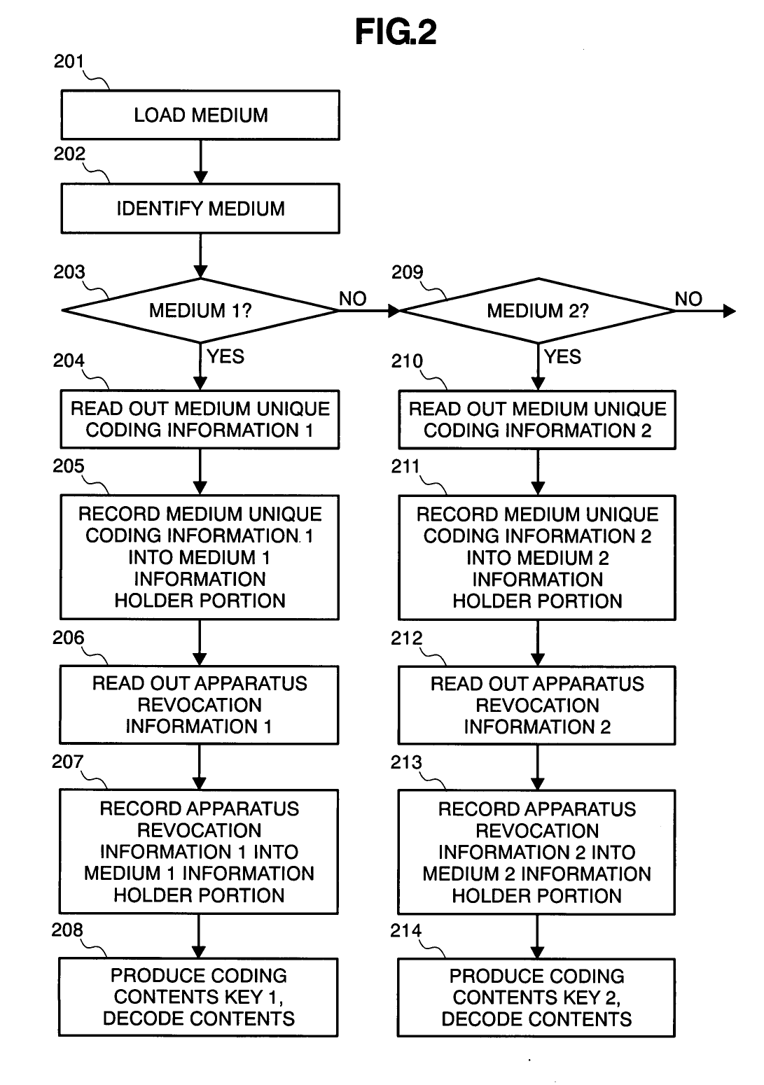

Next, explanation will be made on the processing steps, within the recording/reproducing apparatus according to the present invention, in particular, when loading a medium therein, which is different in the format, for example, the recording pitch, the position of the recording surface in the direction of plate thickness thereof, by referring to FIG. 2. As is shown in FIG. 2, the medium is loaded into the recording/reproducing apparatus (not shown in the figure) according to the present invention (201), and then medium identification is conducted (202). In case where it is the medium 1, as a result of the identification (203), the medium unique coding information 1 is read out (204), and that medium unique coding information 1 is recorded into the medium 1 information holder portion (205).

Further, the apparatus revocation information 1 is read out (206), and that apparatus revocation information 1 is recorded into the medium 1 information holder portion (207). And, a coding contents key 1 is produced, so as to decode the contents therewith. Also, in case when it is determined to be a medium 2 (209), in the medium determination mentioned above, the medium unique coding information 2 is read out (210), and that medium unique coding information 2 is recorded into the medium 2 information holder portion (211). Further, the apparatus revocation information 2 is read out (212), and that apparatus revocation information 2 is recorded into the medium 2 information holder portion (213). And, a coding contents key 2 is produced, so as to decode the contents therewith.

In this manner, with the steps shown in FIG. 2, the same copyright information on the plural number of formats can be held for each of the formats, independently, and the reproduction of the contents on each of the media, the copyrights of which are protected, and the certification of the apparatus with using the revocation information can be achieved with certainty.

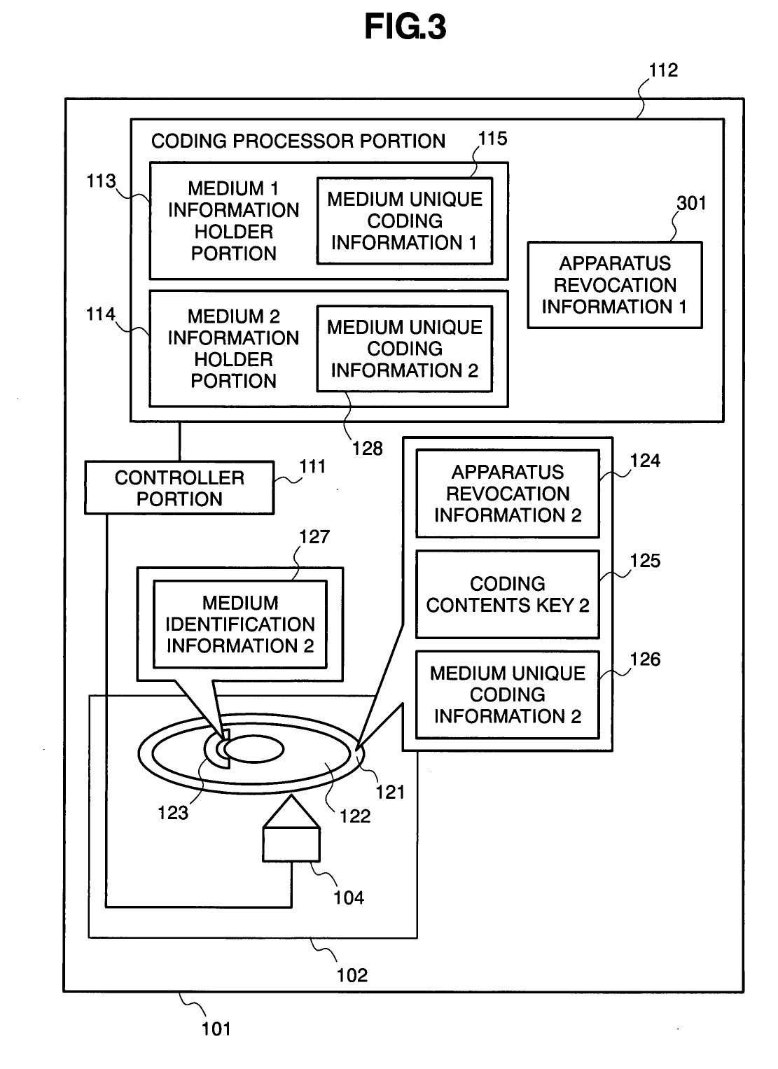

Next, other embodiment of the present invention will be shown, by referring to FIG. 3. However, the components or structures, being similar to those shown in the previous figures, are attached with the same reference numerals. In this FIG. 3, a reference numeral 301 depicts apparatus revocation information 1, which is shared among the plural number of media. In the present embodiment, explanation will be made on the case where the apparatus revocation information can be used, in common, among the copyright protection information on the plural number of formats, for example. Read-in is made on the apparatus revocation information (2) 124, which is recorded in the contents recording region 122 on the optical disk 121, thereby to confirm the version thereof (but, not shown in the figure).

In this instance, when the apparatus revocation information (1) 301, which was held in advance in the apparatus, is higher in the version thereof, it is determined that the apparatus revocation information held within the apparatus is the newest, and then the apparatus revocation information (1) 301 is held within the apparatus, as it is. Further, when they are different in the version, calculation is made on a logical sum (OR) of each of the apparatus revocation information, and the result thereof is reserved, so that the memory region within the apparatus can be used effectively. Also, the present embodiment is in the case where the apparatus revocation information can be shared in common, but it is also similar when to the case where the coding contents key and the medium unique coding information can be shared in common.

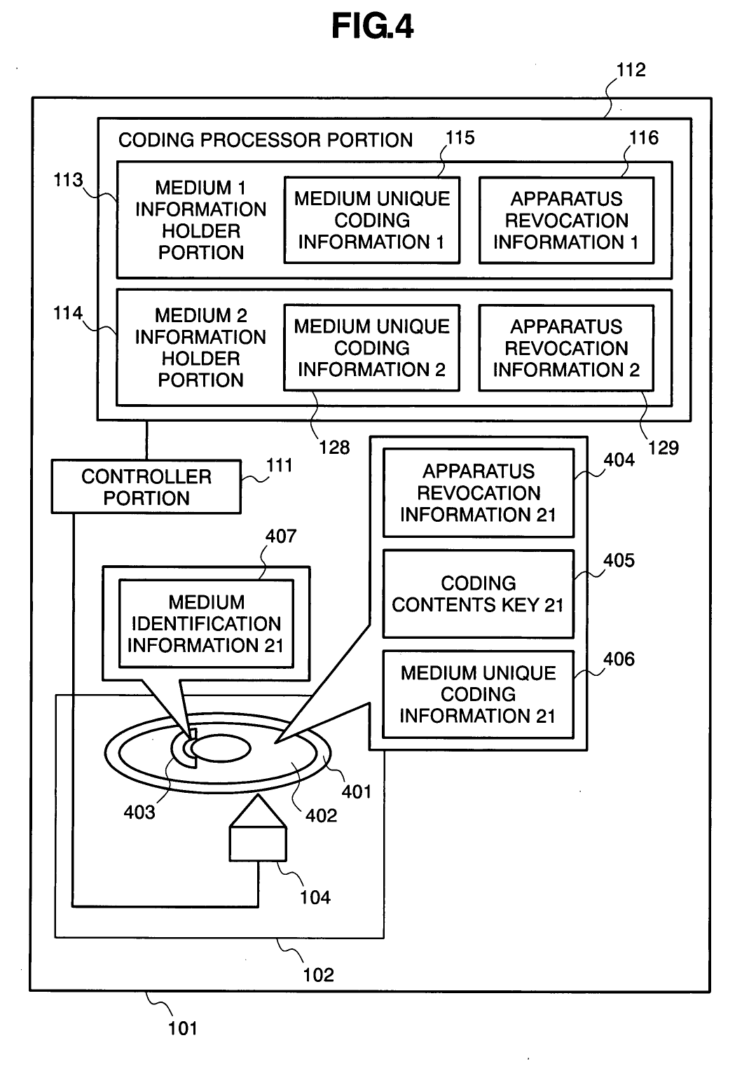

Next, an embodiment is shown in FIG. 4, when recording, according to the present invention, such as, when copying or moving the contents to another disk, etc., for example. However, the components or structures, being similar to those shown in the previous figures, are attached with the same reference numerals. In this FIG. 4, a reference numeral 401 depicts a recordable optical disk, 402 a contents recording area or region, 403 a protection region for recording the medium identification information (21) 407 on the recordable optical disk 401, 404 the apparatus revocation information 21 recorded within the contents recording region 402, 405 the apparatus revocation information 21, and 406 the apparatus revocation information 21, respectively.

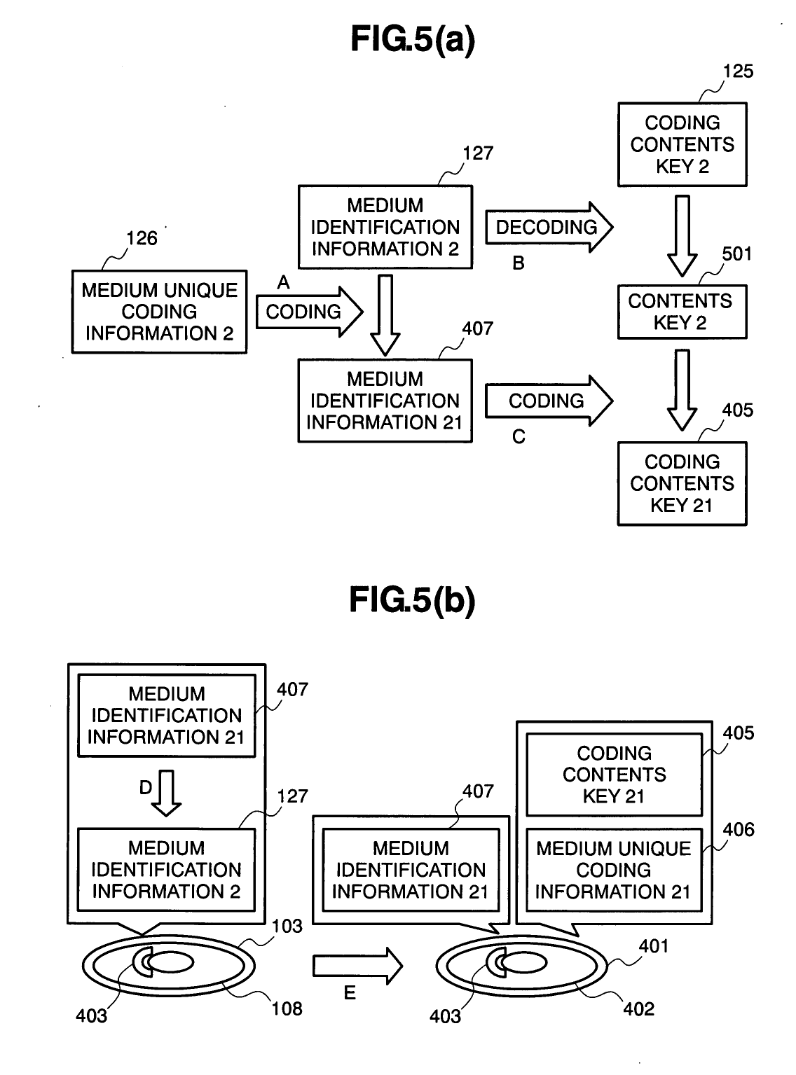

As is shown in FIG. 4, determination is made of the kind or sort of the medium upon the writable optical disk 401, and then the effective medium identification information 21 is recorded into the protection region 403. Further, within the contents recording region are recorded the effective apparatus revocation information (21) 404, the coding contents key (21) 405 and the medium unique coding information (21) 406, upon basis of the medium identification result. Next, by referring to FIGS. 5(a) and 5(b), explanation will be made, in relation to the processing steps onto this writable disk. However, the components or structures, being similar to those shown in the previous figures, are attached with the same reference numerals. In FIGS. 5(a) and 5(b), a reference numeral 501 depicts a contents key 2, which is produced by decoding the coding contents key 2.

As is shown in FIG. 5(a), when recording the writable optical disk (not shown in the figure), coding (see an arrow A) is made on the medium identification information (2) 127 by the medium unique coding information (2) 126, for example, thereby producing the medium identification information (21) 307. Then, decoding is made on the coding contents key (2) 125 by the medium identification information (2) 127, so as to produce the contents key (2) 501, and further coding is made on the contents key (2) 501 by the medium identification information (21) 407, thereby producing the coding contents key (21) 405.

Furthermore, as is shown in FIG. 5(b), the medium identification information (21) 407 is recorded in the protection region 403 of the recordable optical disk 401, and further the coding contents key (21) 405 and the medium unique coding information (21) 406 are recorded within the contents recoding region 402 thereof.

With such the structures as was mentioned above, it is possible to achieve the coding process and also the certifying operation by means of the revocation information, effectively, with accuracy thereof, by holding the necessary coding information, separately, for each kind of the media, or sharing them in common, when reproducing and recording the contents recorded on the media of the plural number of formats, upon which the copyright protection is made.

While we have shown and described several embodiments hereinbefore, in accordance with our invention, but it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A recording/reproducing apparatus, comprising:
a recording/reproducing portion, which is configured to record contents data coded on media, being same in a copyright protection regulation that is applied by the media differing in formats thereof, and to reproduce the contents data on said media; and
a code processing portion, which is configured to take out coded information of said contents data, to conduct a coding process thereon, wherein
identification is made on format information of said medium, to hold said coding information within the apparatus, separately, for each of said format information, thereby holding the information of copyright protection regulations of said media differing in the formats thereof, so as to share them in common.

2. The recording/reproducing apparatus, as described in the claim 1, further comprising:
a second code processing portion, which is configured to control an operation of the apparatus by apparatus revocation information, which is recorded on said medium, wherein
an identification is made on format information of said medium, thereby to hold said apparatus revocation information, separately, for each of said format information.

3. The recording/reproducing apparatus, as described in the claim 2, wherein comparison is made on said apparatus revocation information for each of the different format information held within the apparatus, and when they are coincident with, said apparatus revocation information, which are coincident with, is shared with, in common, between the media of different format information.

4. The recording/reproducing apparatus, as described in the claim 1, wherein the coding information unique to the medium, which is held within said apparatus, is selected from the recordable formats of media, to be taken out, when reserving said decoded contents data onto the recordable medium, thereby coding process thereon.

5. The recording/reproducing apparatus, as described in the claim 2, wherein the apparatus revocation information for each medium information, which is held within said apparatus, is selected by the recordable formats of media, to be taken out, when reserving said decoded contents data onto the recordable medium, thereby recording it.
